(19) United States
(12) Patent Application Publication
(10) Pub. No.: US 2010/0172167 A1
(43) Pub. Date: Jul. 8, 2010

(54) METHOD AND APPARATUS OF AN IMPROVEMENT IN PWM SWITCHING PATTERNS

(76) Inventor: YANG YE, Mississauga (CA)

Correspondence Address: Yang Ye, 2802-310 Burnhamthorpe Rd. W, Mississauga, ON, L5B4P9, CA

(21) Appl. No.: 12/350,253

(22) Filed: Jan. 8, 2009

(51) Int. Cl. H02M 7/537

(52) U.S. Cl. 363/131

(57) ABSTRACT

An improvement in PWM switching patterns applicable for almost all voltage source converters is disclosed. Conventional PWM switching patterns, including carrier based PWM, spacer vector PWM, hysteretic switching pattern, etc, contain a lot of unnecessary switching events. In the present invention, most of the unnecessary switching events are eliminated. The benefits of the method include the significant reduction in control power dissipation which is very attractive especially in high power applications; no risk of shoot through; and no need for deadtime. This method can be easily applied to all existing switching patterns with a little modification. The modification can be in hardware, if the original switching pattern is generated in hardware; it can also be in software, if the original switching pattern is generated in software.

### BACKGROUND

1. Field of the Invention

The present invention relates to power electronics, and more particularly to a method and apparatus of an improvement in switching pattern for PWM power inverters.

2. Background Information

There are many different kinds of PWM switching patterns for voltage source converters. In most of the commonly used switching patterns, there are a lot of unnecessary switching events. Since in voltage source converters, all switches are accompanied by an anti-parallel diode. When the current is flowing through the diode, there is no need to give a switching command. However, in conventional switching patterns, a lot of switching commands are given to the switches where the current flows through the diode. The disclosed invention finds a way to mask most of such switching events, so that switching command is given only when necessary. The solution can be implemented in logic circuits or in software. The benefits include significant reduction in control power dissipation, improvement in reliability due to no risk in shoot-through, elimination of deadtime, improvement in the current waveform because there is no distortion caused by deadtime.

### SUMMARY OF THE INVENTION

The embodiments of the present invention are directed to the method and apparatus of improving PWM switching patterns for voltage source converters. Depending on the sign of the ac side current reference, one of the two switches in the same leg is commanded off. The other switch in the same leg is switched normally according to the previous switching pattern. Since the ac side current changes sign once every half line cycle, so during each half cycle, there is one switch in each leg being kept off all the time. Instead of being switched at the switching frequency all the time, with the new method, each switch will be off for half cycle, then be switched at normal switching frequency for the next half cycle. The switching events are cut by half. Also, since there is always one switch being off in each leg, there is no risk of shoot through, so deadtime is not required any more.

### BRIEF DESCRIPTION OF FIGURES

FIG. 1 shows the current paths and switch status when the current flows to DC side with conventional switching patterns;

FIG. 2 shows the current paths and switch status when the current flows to AC side with conventional switching patterns;

FIG. 3 show the current paths and switch status under the condition of iref(t)>0 and i(t)>0 in the present invention;

FIG. 4 shows the current paths and switch status under the condition of iref(t)<0 and i(t)<0 in the present invention;

FIG. 5 shows the current paths and switch status under the condition of iref(t)>0 and i(t)<0 in the present invention;

FIG. 6 shows the current paths and switch status under the condition of iref(t)<0 and i(t)>0 in the present invention;

FIG. 7 shows the current paths and switch status under the condition of iref(t)=0, i(t)>0 and S1=0 in the present invention;

FIG. 8 shows the current paths and switch status under the condition of iref(t)=0, i(t)<0 and S1=0 in the present invention;

FIG. 9 shows the current paths and switch status under the condition of iref(t)=0, i(t)>0 and S2=0 in the present invention;

FIG. 10 shows the current paths and switch status under the condition of iref(t)=0, i(t)<0 and S2=0 in the present invention;

FIG. 11 shows the current paths and switch status under the condition of iref(t)=0, i(t)>0 and S1=S2=0 in the present invention;

FIG. 12 shows the current paths and switch status under the condition of iref(t)=0, i(t)<0 and S1=S2=0 in the present invention;

FIG. 13 shows the hardware implementation which is also the IC block diagram of the present invention;

FIG. 14 shows the software flow chart of the present invention.

### DETAILED DESCRIPTION OF THE PREFERRED EMBODIMENTS

It is noticed that many switching events in voltage source converters with conventional switching patterns as being ‘unnecessary’. To be ‘unnecessary’ means that a turn-on command is given to a switches where the current flows through the anti-parallel diode.

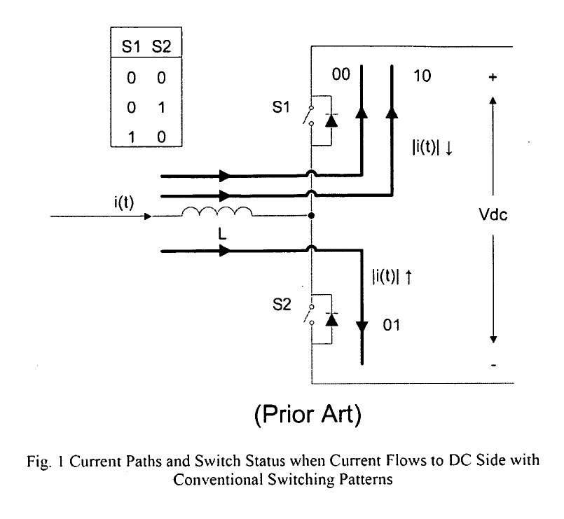

FIG. 1 shows one leg of a voltage source converter. The converter can be single phase, or three-phase, or even more phases. Focus on only one leg. Let the dc side voltage be Vdc, with the positive terminal on the top and the negative terminal on the bottom. Let S1 and S2 are the two switches in the same leg. S1 is the switch on the top, with one terminal connected to the positive terminal of the dc voltage, and the other terminal connected to S2. S2 is the switch on the bottom, with one terminal connected to the negative terminal of the dc voltage, and the other terminal connected to S1. The common point of S1 and S2 is connected to one terminal of the inductor L. The other terminal of the inductor L is connected to the ac side of the converter. The switch status is either on or off. Denote the switch status to be logic ‘1’ if it is on, and logic ‘0’ if it is off. In any conventional switching pattern for voltage source converter, there are three possible combinations of the switch status for S1 and S2. The possible combinations are listed in the table on the top-left side of FIG. 1. The thick traces with arrows indicate the current paths corresponding to a certain switch status, which is written besides the trace. Status ‘00’ means both switches are off, status ‘01’ means S1 is off and S2 is on; and status ‘10’ means S1 is on the S2 is off. Status ‘11’ is an illegal status because it is not allowed to have both switches to be on at the same time. Assume in FIG. 1, the ac side current i(t) is flowing from the ac side to the dc side. With the three possible status of switches, there are only two possible current paths. The status ‘00’ and ‘10’ share the same current path, which is from the inductor to S1, then to the positive terminal of the dc voltage. When the status is ‘01’, the current path is from the inductor to S2, then to the negative terminal of the dc voltage. This means that no matter S1 is on or off, there is no difference in the current path. So under the condition of the current flowing from the ac side to the dc side, S1 can be kept off without changing the actual current flow.

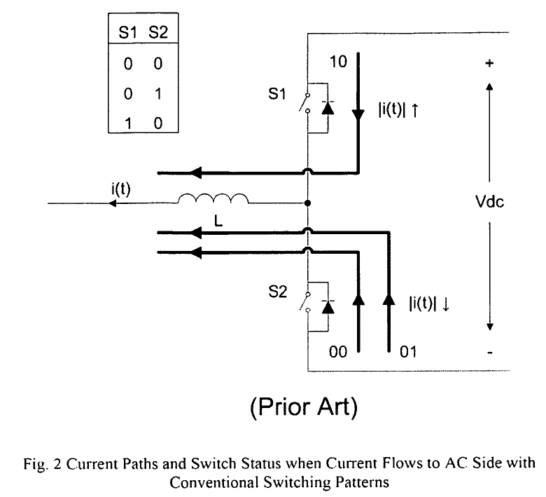

FIG. 2 shows the opposite condition, where the current flows from the dc side to the ac side. The status of the switches have the same possible combinations. The status ‘00’ has the same current path as the status ‘01’. The current flows from the negative terminal of the dc voltage through S2's anti-parallel diode to the inductor. When the status is ‘10’, the current flows from the positive terminal of the dc voltage to S1, and then to the inductor. In this case, the switching command for S2 has no effect on the current flow. S2 can be kept off when the current flows from the dc side to the ac side.

The current changes direction every half of the line cycle. From FIG. 1 and FIG. 2, it can be seen that according to the direction of the current, one of the two switches in the leg can be kept off for half cycle. In conventional switching patterns, every switch is switched once in each switching cycle no matter what direction the current flows. So for each switching device, half of the switching events can be removed without changing the current path.

However, since the actual measured current contains high frequency noise and errors, the measured direction might be wrong, especially when the current level is low. To solve the problem, instead of using the actual current, the current reference signal is used to determine the switch status. Since the current reference is a derived variable which is free of noise, it is a reliable source. Since most of the voltage source converters use current mode control, so the current reference signal is readily available.

In the present invention, the most important improvement in the switching pattern is to use the current reference to determine which switch to be kept off in each leg.

Without losing generosity, define the current to be positive if it flows from the ac side to the dc side. Call the current reference iref(t), and the actual current i(t). The rules in the present invention are:

No matter what kind of switching pattern is used, if iref(t)>0, then S1 is off, S2 is switched normally according to its old switching pattern; if iref(t)<0, then S2 is off, S1 is switched normally according to its old switching pattern; if iref(t)=0, then any one of S1 and S2 is off and the other one is switched normally according to its old switching pattern; they can also be both off.

In the following embodiments, it is verified that the current reference can be used to determine how to modify the switching pattern. The following conditions need to be considered:

iref(t)>0 and i(t)>0;

iref(t)<0 and i(t)<0;

iref(t)>0 and i(t)<0;

iref(t)<0 and i(t)>0;

iref(t)=0 and i(t)>0, keep S1=0;

iref(t)=0 and i(t)<0, keep S1=0;

iref(t)=0 and i(t)>0, keep S2=0;

iref(t)=0 and i(t)<0, keep S2=0;

iref(t)=0 and i(t)>0, keep S1=S2=0;

iref(t)=0 and i(t)<0, keep S1=S2=0.

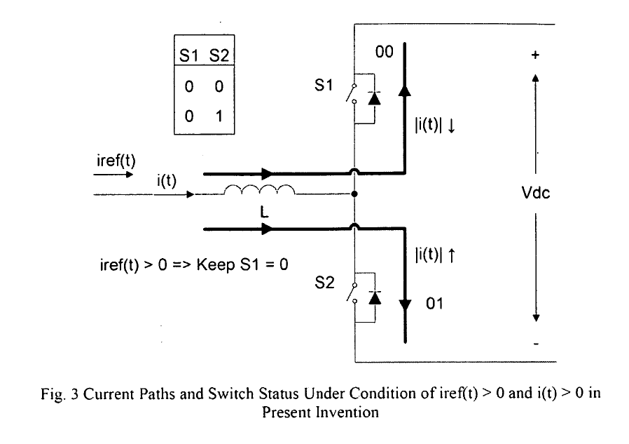

FIG. 3 shows the condition of iref(t)>0 and i(t)>0. So S1 is kept off by keeping S1=0. When S2=1, the current flows to the negative terminal of the dc voltage, resulting to an increase in the current level; when S2=0, the current flows to the positive terminal of the dc voltage, resulting to a decrease in the current level. By switching S2 on and off, the current level can be effectively controlled. During the switching of S2, S1 is always off, so there is no risk of shoot through, and there is no need to have any deadtime when S2 is switched.

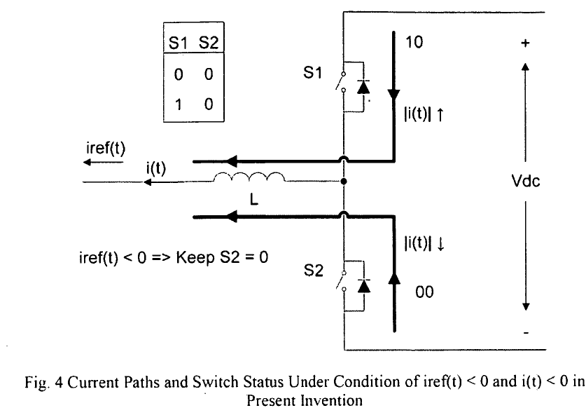

FIG. 4 shows the condition of iref(t)<0 and i(t)<0. So S2 is kept off by keeping S2=0. When S1=1, the current flows from the positive terminal of the dc voltage, resulting to an increase in the current level; when S1=0, the current flows from the negative terminal of the dc voltage, resulting to a decrease in the current level. By switching S1 on and off, the current level can be effectively controlled. During the switching of S1, S2 is always off, so there is no risk of shoot through, and there is no need to have any deadtime when S1 is switched.

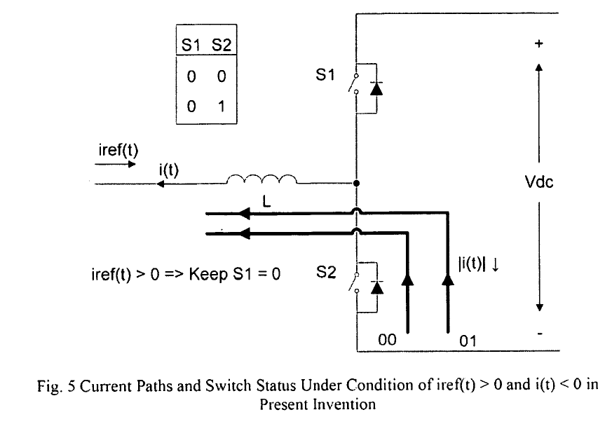

FIG. 5 shows the condition of iref(t)>0 and i(t)<0. This happens during the zero crossing of the current, where the current reference just changes the direction and the actual current is close to zero but need to follow the change. Since iref(t)>0, S1 is kept off by keeping S1=0. In this case, no matter what the status of S2 is, the current always flows through the anti-parallel diode of S2, resulting to a decrease in current level until it becomes zero. This is the desired situation. When the current level is reduced to 0, it will change the direction, and then covert to the condition as in FIG. 3. Under this condition, the current is also controlled effectively. Since S1 is always off, there is no risk of shoot through, and there is no need to have any deadtime when S2 is switched. The switching of S2 under this condition is unnecessary; however, since this happens only at zero crossing when the current changes from negative to positive, it is acceptable.

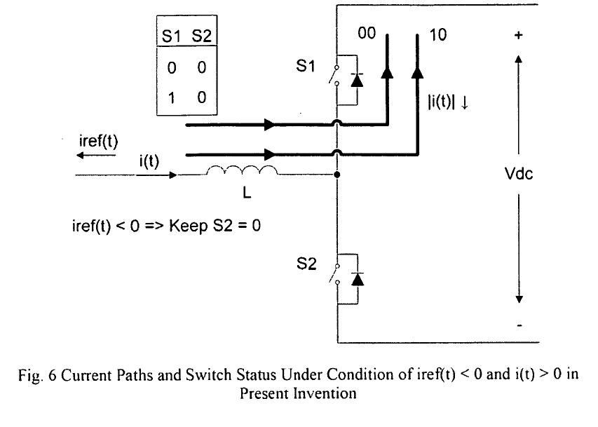

FIG. 6 shows the condition of iref(t)<0 and i(t)>0. This happens during the zero crossing, of the current, where the current reference just changes the direction and the actual current is close to zero but need to follow the change. Since iref(t)<0, S2 is kept off by keeping S2=0. In this case, no matter what the status of S1 is, the current always flows through the anti-parallel diode of S1, resulting to a decrease in current level until it becomes zero. This is the desired situation. When the current level is reduced to 0, it will change the direction, and then covert to the condition as in FIG. 4. Under this condition, the current is also controlled effectively. Since S2 is always off, there is no risk of shoot through, and there is no need to have any deadtime when S1 is switched. The switching of S1 under this condition is unnecessary; however, since this happens only at zero crossing when the current changes from positive to negative, it is acceptable.

iref(t)=0 is a rare case which only happens in zero-crossing. An absolute zero current reference is very unlikely. It is more likely to happen when software switching control is applied. In the following embodiments, it is shown that multiply solutions are acceptable: keep S1 off, or keep S2 off, or keep both off.

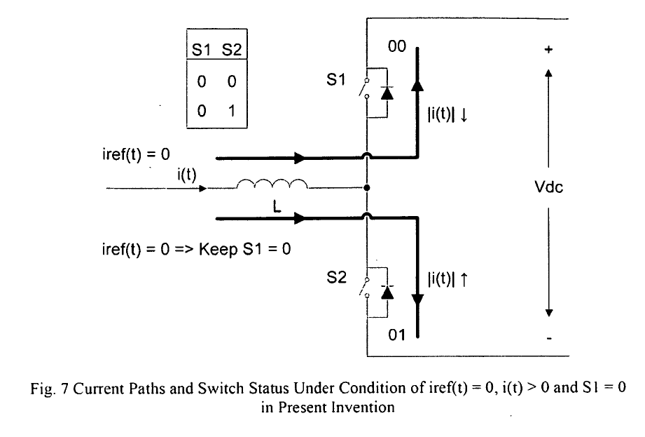

FIG. 7 shows the condition of iref(t)=0, i(t)>0, and keep S1=0. When S2=1, the current flows to the negative terminal of the dc voltage, resulting to an increase in the current level; when S2=0, the current flows to the positive terminal of the dc voltage, resulting to a decrease in the current level. By switching S2 on and off, the current level can be effectively controlled. During the switching of S2, S1 is always off, so there is no risk of shoot through, and there is no need to have any deadtime when S2 is switched. Note in this case, the most effective way of controlling the current is to keep both switches off, so that the only possible current path is to the positive terminal of the dc voltage, which will lead to a decrease in current level. Since this is only during zero crossing transient, it is acceptable.

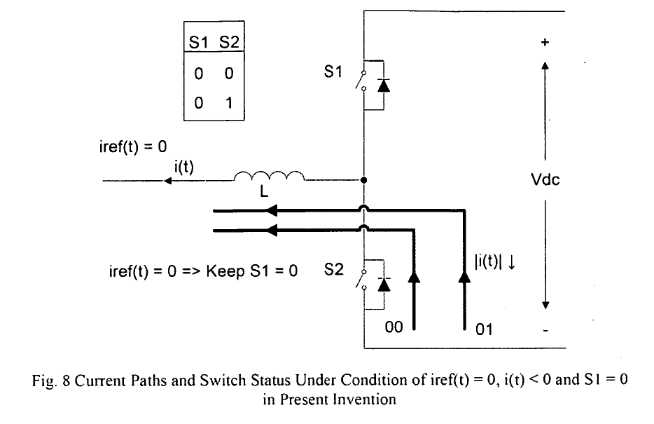

FIG. 8 shows the condition of iref(t)=0, i(t)<0, and keep S1=0. In this case, no matter what the status of S2 is, the current always flows through the anti-parallel diode of S2, resulting to a decrease in current level until it becomes zero. During the switching of S2, S1 is always off, so there is no risk of shoot through, and there is no need to have any deadtime when S2 is switched. The switching of S2 under this condition is unnecessary; however, since this happens only at zero crossing when the current changes from positive to negative, it is acceptable.

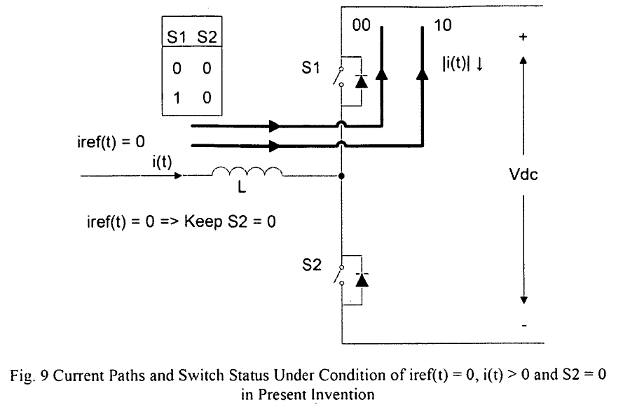

FIG. 9 shows the condition of iref(t)=0, i(t)>0, and keep S2=0. In this case, no matter what the status of S1 is, the current always flows through the anti-parallel diode of S1, resulting to a decrease in current level until it becomes zero. During the switching of S1, S2 is always off, so there is no risk of shoot through, and there is no need to have any deadtime when S1 is switched. The switching of S1 under this condition is unnecessary; however, since this happens only at zero crossing when the current changes from positive to negative, it is acceptable.

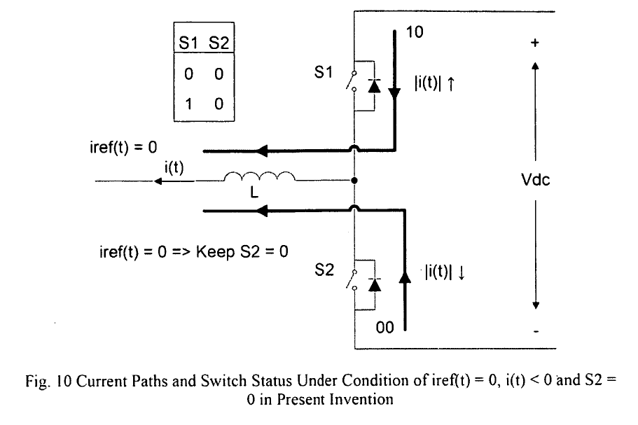

FIG. 10 shows the condition of iref(t)=0, i(t)<0, and keep S2=0. When S1=1, the current flows from the positive terminal of the dc voltage, resulting to an increase in the current level; when S1=0, the current flows from the negative terminal of the dc voltage, resulting to a decrease in the current level. By switching S1 on and off, the current level can be effectively controlled. During the switching of S1, S2 is always off, so there is no risk of shoot through, and there is no need to have any deadtime when S1 is switched. Note in this case, the most effective way of controlling the current is to keep both switches off, so that the only possible current path is from the negative terminal of the dc voltage, which will lead to a decrease in current level. Since this is only during zero crossing transient, it is acceptable.

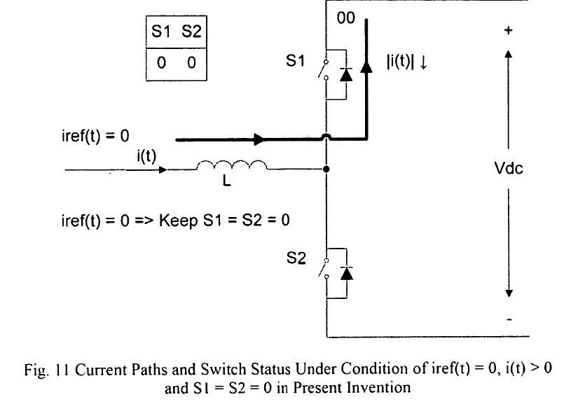

FIG. 11 shows the condition of iref(t)=0, i(t)>0, and keep S1=S2=0. With both switches, off, the only current path is to the positive terminal of the dc voltage, which leads to a decrease in current. This is the most effective way of controlling the current for this condition. There is no switching involved, so there is no shoot through risk, and no deadtime is required.

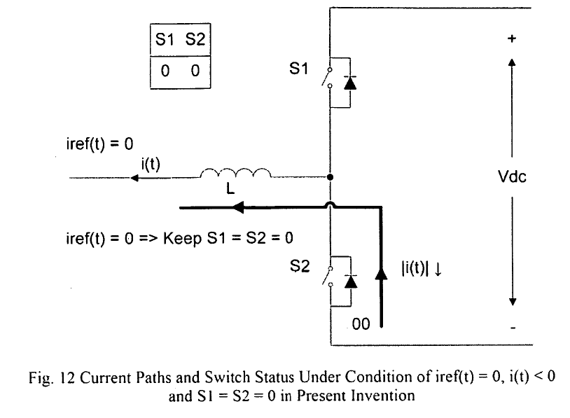

FIG. 12 shows the condition of iref(t)=0, i(t)<0, and keep S1=S2=0. With both switches, off, the only current path is from the negative terminal of the dc voltage, which leads to a decrease in current. This is the most effective way of controlling the current for this condition. There is no switching involved, so there is no shoot through risk, and no deadtime is required.

The above analysis includes all possible combinations of the current reference and the actual current. It is proved that this method can cover all above conditions.

The method can be used with any existing switching patterns. The implementation of the method can be either in hardware or in software, mainly depending on how the original switching pattern is implemented.

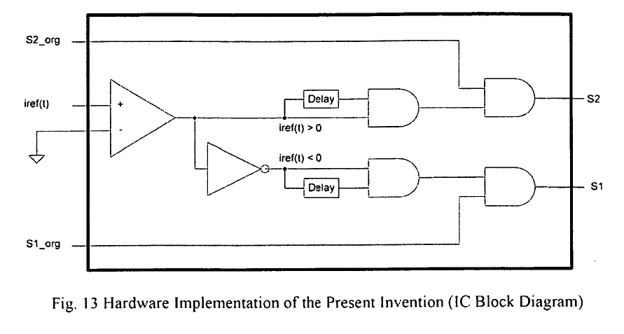

When implemented in hardware, FIG. 13 is an example of the implementation for one leg. The inputs to the circuit is S1_org, S2_org and iref(t), where S1_org and S2_org are the original switching signals generated from original switching patterns without the deadtime. The deadtime in the original switching pattern should be disabled to get most of the benefit from the present invention. iref(t) is sent to a zero-crossing detector in this circuit to get a logic signal of iref(t)>0 and its inverse which is iref(t)<0. The delay block and the AND gates after each of iref(t)>0 and iref(t)<0 signals are a kind of ‘deadtime’ for zero-crossing of iref(t). This part of circuit is activated once in half cycle. From previous analysis, it is shown that when iref(t) is close to 0, it is better to keep both switches off, so as to control the actual current more effectively. The small deadtime for iref(t) serves for this purpose, and it makes the transfer of the zero-crossing more reliable. The two AND gates on the right side achieve the logic for the switching pattern. When iref(t)>0, keep S1 off; when iref(t)<0, keep S2 off.

The circuit inside of the heavy line block can be integrated to an integrated circuit. The IC can be seamlessly inserted between the original gates signals and the gate drive. With this circuit, there is no change in the system level control, but the performance is improved significantly, especially in control power dissipation and deadtime distortion.

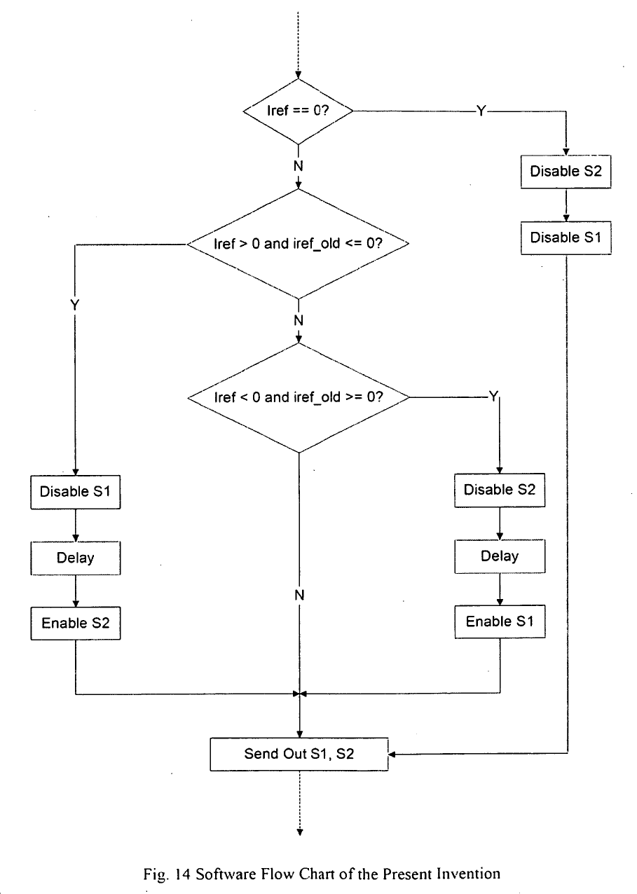

When the method is implemented in software, FIG. 14 provides an example of software flow chart. This flow chart serves as a patch to any existing software which uses whatever switching pattern. This provides an add-on feature to the existing switching pattern. To get most of the benefit, the deadtime in the existing switching pattern should be removed. When entering into this part of the code, the status of S1 and S2 should have already been determined using the original switching pattern. Before they are sent out, the current reference Iref is check. If it is zero, then disable both S1 and S2, which makes both switches off. If Iref is not zero, then check if it is at the rising edge of the zero-crossing, by check both the present Iref and the previous value Iref_old. If it is at the rising edge of the zero-crossing, then disable S1, after a little delay, enable S2, and send out the switching command. Then in the following half cycle, S1 will be 0 and S2 will be the same as in the original pattern. If it is not at the rising edge of the zero-crossing, check if it is at the falling edge of the zero-crossing. If it is, then disable S2, after a little delay, enable S1, and send out the switching command. Then in the following half cycle, S1 will be the same as in the original pattern and S2 will be 0. If it is not at zero-crossing, then no change is made on which switch to disable. The same switch is disabled as in the last time.

While exemplary embodiments described hereinabove, it should be recognized that these embodiments are provided for illustration and are not intended to be limitative. Any modifications and variations, which do not depart from the spirit and scope of the invention, are intended to be covered herein.

What is claimed:

1. A method and apparatus of improving the switching patterns for voltage source converters, wherein all existing switching patterns for voltage source converters can be improved, and voltage source converters include single phase, three-phase, multi-phase converters, and any kinds of converters with one dc side voltage and a plurality of legs, wherein each leg contains two switches connected in series with one end of one switch connecting to the positive terminal of the dc voltage, one end of the other switch connecting to the negative terminal of the dc voltage, and the common end of the two switches connecting to one end of an inductor. The other end of the inductor is connected to the ac side of the converter.
The key to the improvement is to turn off a selected switch in each one leg of the converter during half cycle according to the direction the current reference.

2. The apparatus of claim 1, wherein the selected switch to be turned off is the switch connected to the positive terminal of the dc voltage if the current reference is from the ac side to the dc side. This switch is to be kept off for the half cycle when the current reference is in the same direction of being from the ac side to the dc side.

3. The apparatus of claim 1, wherein the selected switch to be turned off is the switch connected to the negative terminal of the dc voltage if the current reference is from the dc side to the ac side. This switch is to be kept off for the half cycle when the current reference is in the same direction of being from the dc side to the ac side.

4. The apparatus of claim 1, wherein the selected switch to be turned off can be either one in the leg or both if the current reference is changing its direction. The most effective way is to turn off both switches when the current reference is changing its direction.

5. The apparatus of claim 1, 2, 3 and 4, wherein the improvement in the switching pattern is implemented in hardware. The circuit diagram is shown in FIG. 13.

6. The apparatus of claim 5, wherein a deadtime is generated at the zero-crossing of the current reference to make sure when the current reference changes direction, both switches in the same leg are kept off. The deadtime is activated once every half cycle.

7. The apparatus of claim 5, wherein the circuit is built into an integrated circuit.

8. The apparatus of claim 1, 2, 3 and 4, wherein the improvement in the switching pattern is implemented in software. The software flowchart is shown in FIG. 14.

9. The apparatus of claim 8, wherein a deadtime is generated using a software delay at the zero-crossing of the current reference to make sure when the current reference changes direction, both switches in the same leg are kept off. The deadtime is activated once every half cycle.
